(19) United States
(12) Patent Application Publication
(10) Pub. No.: US 2007/0183952 A1
(43) Pub. Date: Aug. 9, 2007

(54) Catalytic oxidation system

(75) Inventors: Jeffrey D. Jordan, Williamsburg, VA (US); Anthony N. Watkins, Hampton, VA (US); Bradley D. Leighty, Gloucester, VA (US); Patricia P. Davis, Yorktown, VA (US); David R. Schryer, Hampton, VA (US); Richard J. Schwartz, Hayes, VA (US); Jacqueline L. Schryer, Hampton, VA (US); Donald M. Oglesby, Virginia Beach, VA (US)

Correspondence Address: NATIONAL AERONAUTICS AND SPACE ADMINISTRATION;LANGLEY RESEARCH CENTER, MAIL STOP 141, HAMPTON, VA, 23681-2199, US

(73) Assignee: U.S.A as represented by the Administrator of the National Aeronautics and Space Administration, Washington, DC (US)

(21) Appl. No.: 10/795,097

(22) Filed: Mar. 4, 2004

(51) Int. Cl. B01D 53/34; B01D 47/00; B01D 50/00; B01D 53/94

(52) U.S. Cl. 423/212; 422/177; 422/180

(57) ABSTRACT

An exhaust gas treatment system having an exhaust gas inlet section, an oxygen enrichment system, catalyst holding arms, and an exhaust gas outlet section is disclosed. The exhaust gas inlet and outlet sections can be designed to mate to existing exhaust gas plumbing systems for industrial facilities. The optional oxygen enrichment system helps optimize catalytic performance by maintaining excess oxygen in the exhaust gas stream and by imparting greater turbulence to the exhaust gas stream. Disposed within each catalyst holding arm is at least one catalyst coated substrate where the catalytic oxidation of formaldehyde and other volatile organic compounds occurs. The catalytic substrate can be catalyst coated bricks, particles, beads, fabrics, or filter materials. Each catalyst holding arm can be selectively closed off using upstream and downstream isolation valves. Catalyst coated substrate longevity can be increased by the inclusion of an optional filter upstream of the catalyst coated substrates.

### ORIGIN OF INVENTION

The invention described herein was made in the performance of work under a NASA contract and by employees of the United States Government and is subject to the provisions of Public Law 96-517 (35 U.S.C. §202) and may be manufactured and used by or for the Government for governmental purposes without the payment of any royalties thereon or therefor. In accordance with 35 U.S.C. §202, the contractor elected not to retain title.

### FIELD OF THE INVENTION

The present invention relates to the catalytic treatment of exhaust gases. More specifically, the present invention relates to an apparatus for the catalytic treatment of exhaust gases.

### BACKGROUND OF THE INVENTION

Many industrial processing schemes involve the heating of raw materials to enable mold castings (e.g., plastics), thin film fabrication (e.g., microelectronics), and extrusion (e.g., filter materials) as the first step in product manufacturing, to name just a few. The heating of polymeric and other man-made materials can liberate volatile organic compounds (VOCs). VOCs may be harmful to the environment. Of particular concern is the emission of formaldehyde, which has been the subject of investigation and regulation by the U.S. Environmental Protection Agency.

Existing technologies for the remediation of formaldehyde from industrial smoke stack effluent streams include water misting and total combustion furnace technologies. In the former method, the emission stream is subjected to a water mist, which serves to condense formaldehyde and other VOCs. The formaldehyde and VOCs are captured in the collected water. The formaldehyde-contaminated water is then recovered and shipped to chemical processing facilities where the formaldehyde is removed from the water and destroyed by conventional means. This is a time-consuming and costly process that exhibits insufficient capacity to remove formaldehyde at levels encountered in the heating of many classes of industrial-use resin materials. Total combustion furnaces do not suffer the limitations of water-misting technologies; however, they are very costly to procure, integrate, and maintain for the purpose of reducing VOC emissions, specifically formaldehyde emissions in industrial processing facilities.

NASA low-temperature oxidation catalyst (LTOC) technology was originally developed for space-based carbon dioxide (CO₂) laser systems, and has subsequently been adapted to effect catalytic oxidation of carbon monoxide (CO) and VOC species (e.g., hydrocarbons, aldehydes, and keytones) to CO₂ and water, and to reduce nitrogen oxide species (NOx) to molecular nitrogen and (N₂) and oxygen (O₂). Moreover, the LTOC technology has been adapted for use in environments ranging from the cold vacuum of space to the extremely high temperature and pressure conditions of internal combustion engines. The existing application heritage of the LTOC supports the integration of this technology for formaldehyde remediation for conditions extending over several decades of pressure and temperature.

Recently, a catalyst for the oxidation of volatile organic compounds has been developed. U.S. Pat. No. 6,132,694, issued to Wood, et al., discloses a process for oxidizing volatile organic compounds to carbon dioxide and water with the minimal addition of energy, which is hereby incorporated herein by reference as if set forth in its entirety. In the disclosed process, a mixture of the volatile organic compound and an oxidizing agent (e.g., ambient air containing the volatile organic compound) is exposed to a catalyst which includes a noble metal dispersed on a metal oxide which possesses more than ones oxidation state. Especially good results are obtained when the noble metal is platinum, and the metal oxide which possesses more than one oxidation state is tin oxide. A promoter (i.e., a small amount of an oxide of a transition series metal) may be used in association with the tin oxide to provide very beneficial results.

Additional oxidation catalysts, and methods for making same, which could potentially be used in or with at least one embodiment of the instant invention, can be found in U.S. Pat. No. 4,855,274 entitled “Process for Making a Noble Metal Oxide Catalyst”; U.S. Pat. No. 4,829,035 entitled “Reactivation Of A Tin Oxide-Containing Catalyst”; U.S. Pat. No. 4,912,082 entitled “Catalyst For Carbon Monoxide Oxidation”; U.S. Pat. No. 4,991,181 entitled “Catalyst For Carbon Monoxide Oxidation”; U.S. Pat. No. 5,585,083 entitled “Catalytic Process For Formaldehyde Oxidation”; U.S. Pat. No. 5,948,965 entitled “Solid State Carbon Monoxide Sensor”; and U.S. Pat. No. 6,132,694 entitled “Catalyst for Oxidation of Volatile Organic Compounds.” These patents are hereby incorporated herein by reference as if set forth in their entirety. Likewise, the following U.S. Patent Applications have been filed for other catalysts and methods that could potentially be used in or with at least one embodiment of the present invention, namely U.S. patent application Ser. No. 09/607,211 entitled “Process for Coating Substrates With Catalyst Materials,” filed on Jun. 30, 2000; Ser. No. 10/056,845 entitled “Methodology for the Effective Stabilization of Tin-Oxide-Based Oxidation/Reduction Catalysts,” filed on Jan. 22, 2002; Ser. No. 10/342,660 entitled “Ruthenium Stabilization For Improved Oxidation/Reduction Catalyst Systems,” filed on Jan. 13, 2003; and Ser. No. 10/601,801 entitled “Method For The Detection Of Volatile Organic Compounds Using A Catalytic Oxidation Sensor,” filed on Jun. 20, 2003. These U.S. Patent Applications are also hereby incorporated herein by reference as if set forth in their entirety.

Thus, there is a need to develop a chemical oxidation system to supplant the current state-of-the-art in pollutant emission remediation by offering a more efficient and cost effective alternative. Therefore, it would be advantageous to provide an exhaust gas treatment system that can incorporate an appropriate catalyst, such as the NASA LTOC technology.

### BRIEF SUMMARY OF THE INVENTION

In view of the insufficiencies discussed above, it is an object of the present invention to apply LTOC technology to the treatment of exhaust gas emissions. It is a further object of the present invention to provide an exhaust gas treatment system that can be easily and cost-efficiently integrated into industrial processing facilities. Furthermore, the present invention will enable industry to comply with U.S. Environmental Protection Agency mandates on formaldehyde and other VOC emissions at significantly lower cost than previous approaches.

Generally, the present invention is an exhaust gas treatment system that provides tremendous flexibility to facilitate integration. The present invention also lends itself to various configurations and scales. The apparatus of the present invention can be plumbed inline with the emission ductwork that typically culminates at a smoke stack interface, known in the art and common to industrial facilities. This allows the present invention to be installed in a new facility or as an upgrade to an existing facility.

In various embodiments, the present invention is comprised of the following primary components: an exhaust gas inlet section, an optional oxygen enrichment system, a plurality of catalyst holding arms, and an exhaust gas outlet section. The exhaust gas inlet and outlet sections can be designed to mate to existing exhaust gas plumbing systems for industrial facilities.

Downstream of the exhaust gas inlet section is the optional oxygen enrichment system that increases the oxygen concentration of the pollutant exhaust gas stream. The oxygen enrichment system contributes to optimizing catalytic performance by maintaining an excess amount of oxygen in the exhaust gas stream and imparting greater turbulence to the exhaust gas stream. The oxygen enrichment system can be an active or passive system. For example, the oxygen enrichment system may contain a plurality of passive oxygen enrichment ports.

lnside the plurality of catalyst holding arms, the catalytic oxidation of carbon monoxide, formaldehyde, and/or other VOCs can occur, additionally the reduction of nitrogen oxide species might also take place. Disposed within each catalyst holding arm is at least one catalyst coated substrate, for example, the NASA LTOC technology. Optionally, each catalyst holding arm can be selectively closed off using upstream and downstream isolation valves. The design of the plurality of catalyst holding arms also can increase catalytic efficiency by controlling the exhaust gas stream volumetric flow rate through each catalytic substrate. Additionally, the exterior of each catalyst holding arm can be covered with a thermal control means, such as heater tape, or similar device, to allow thermal control of the catalytic substrate.

The catalyst substrates are coated with a catalyst formulation optimized for the specific environmental conditions to be encountered. In one embodiment, formaldehyde and other VOCs in the exhaust gas stream are oxidized to CO₂ and water at the catalyst substrate surface, and are subsequently displaced by new pollutant molecules, thereby replenishing the catalytically active catalyst substrate surface. The formaldehyde and reactive VOCs can be oxidized completely to CO₂ and water. The catalytic substrate can be, for example, catalyst coated bricks, particles, beads, fabrics, or filter materials.

Longevity and durability of the catalyst substrates can be increased by the inclusion of an optional filter upstream of the catalyst substrates. Upstream and downstream of the filter, there can be upstream and downstream filter cut-off valves.

Other features and advantages of the invention will be apparent from the following detailed description taken in conjunction with the following drawings, wherein like reference numerals represent like features.

### BRIEF DESCRIPTION OF THE DRAWINGS

FIG. 1 shows one embodiment of the present invention;

FIG. 2 shows one embodiment of a catalyst holding arm of the present invention; and

FIG. 3 shows one embodiment of a catalyst substrate of the present invention.

### DETAILED DESCRIPTION OF THE INVENTION

While this invention is susceptible of embodiments in many different forms, there are, shown in the drawings and will herein be described in detail, specific embodiments of the invention with the understanding that the present disclosure is to be considered as an exemplification of the principles of the invention and is not intended to limit the broad aspect of the invention to the embodiments illustrated.

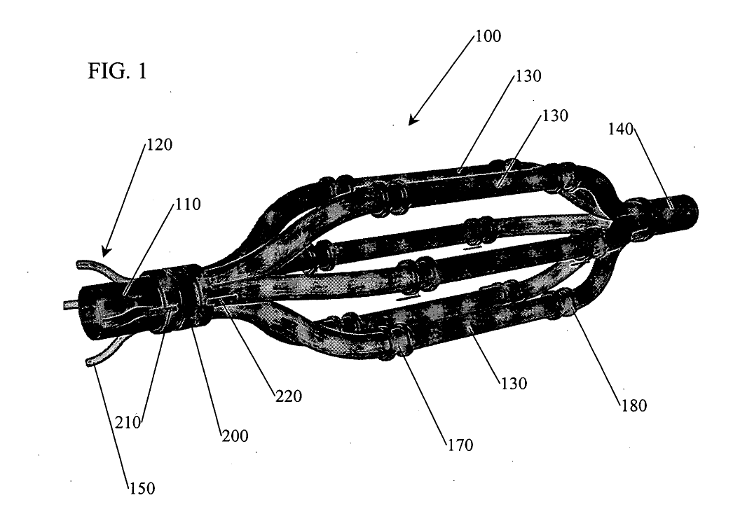

Generally, the present invention is an exhaust gas treatment system 100. The system 100 provides tremendous flexibility to facilitate integration. Additionally, the present invention lends itself to various configurations and scales ranging from sub-one-inch to several feet or more. The present invention is comprised of the following primary components, shown in FIG. 1: an exhaust gas inlet section 110, an optional oxygen enrichment system 120, a plurality of catalyst holding arms 130, and an exhaust gas outlet section 140.

The present invention can be plumbed inline with the emission ductwork that typically culminates at a smoke stack interface, known in the art and common to industrial facilities. The exhaust gas inlet section 110 can be designed to mate to existing exhaust gas plumbing systems for industrial facilities. This allows the present invention to be installed in a new facility or as an upgrade to an existing facility.

Downstream of the exhaust gas inlet section 110 is the optional oxygen enrichment system 120. The optional oxygen enrichment system 120 increases the oxygen concentration of the pollutant exhaust gas stream. The oxygen enrichment system 120 maintains an excess amount of oxygen in the exhaust gas stream to enhance the catalytic oxidation of carbon monoxide, formaldehyde, and other VOCs. The oxygen enrichment system 120 also imparts greater turbulence to the exhaust gas stream which increases the residence time of each pollutant molecule at the catalyst/air interface. Thus, the oxygen enrichment system 120 contributes two-fold to optimizing catalytic performance of the present invention. In oxygen rich environments or for exhaust gas streams having sufficient turbulence, the apparatus of the present invention may still be operable and the optional oxygen enrichment system 120 may not be required.

One embodiment of the oxygen enrichment system 120 comprises a plurality of oxygen enrichment ports 150 located downstream of the exhaust gas inlet section. The oxygen enrichment system 120 can be an active or passive system. An active system can pump air or oxygen into the exhaust gas stream. A passive injection system can allow the influx of air or oxygen using the moving exhaust gas stream to draw air or oxygen into the exhaust gas stream. FIG. 1 shows four passive oxygen enrichment ports 150, however, any desired number of ports may be used.

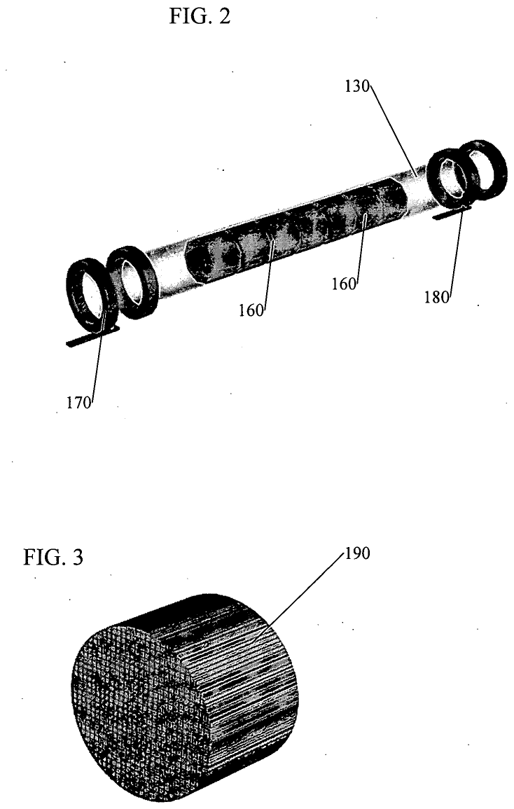

In this embodiment, inside the plurality of catalyst holding arms 130, the catalytic oxidation of formaldehyde and other VOCs occurs. Disposed within each catalyst holding arm 130 is at least one catalyst coated substrate 160, for example, as shown in FIG. 2. Optionally, each catalyst holding arm 130 can be selectively closed off using upstream isolation valves 170 and downstream isolation valves 180. The upstream and downstream isolation valves 170 and 180 allow for maintenance and catalyst refurbishment without shutting down facility operation. In addition, this capability provides a mechanism to increase the pollutant destruction capacity by simply adding additional catalyst substrates 160 and/or additional catalyst holding arms 130 in the plumbing configuration.

As shown, the plurality of catalyst holding arms 130 are approximately equal in length and aligned in the same general direction. In practice, the plurality of catalyst holding arms 130 can vary in length and alignment. Generally, the exhaust gas stream flow through the holding arms 130 is referred to as being parallel, which can be parallel in the geometric sense, but more appropriately, and as intended herein, is parallel in the fluid dynamic or electrical circuit sense. That is, the exhaust gas stream through the apparatus 100 is separated from a single stream into a plurality of exhaust gas streams, wherein each gas stream of the plurality of gas streams flows through a separate catalyst holding arm 130. Further, the plurality of catalyst holding arms 130 need not be geometrically parallel and can include bends or turns in the plumbing. Thus, the term “parallel,” as used herein means parallel in the fluid dynamic sense and not necessarily geometrically parallel.

The design of the plurality of catalyst holding arms 130 also can increase catalytic efficiency. The exhaust gas stream volumetric flow rate, and hence the pollutant residence time at the catalyst substrate 160, can be affected by designing a system in which the combined cross sectional area of the catalyst holding arms 130 is greater than the cross sectional area of the exhaust gas inlet section 110. For example a one-foot diameter exhaust gas inlet section 130 diverging into six 0.5-foot catalyst holding arms 130 would effect a 3-to-1 reduction in the exhaust gas stream volumetric flow rate at the catalyst substrate 160, potentially resulting in a three-fold increase in catalytic efficiency. Additionally, the exterior of each catalyst holding arm 130 can be covered with a thermal control means, either active or passive (not shown), such as heater tape, or similar device, to allow thermal control of the catalytic substrate 160. This further enhances catalytic efficiency, including formaldehyde destruction performance, particularly in cold climates.

The catalyst substrates 160 are coated with a catalyst formulation optimized for the specific environmental conditions (e.g., pressure, temperature, flow rate, pollutant concentration, etc.) to be encountered. Carbon monoxide, formaldehyde, and other VOCs in the exhaust gas stream are oxidized to CO₂ and water at the catalyst substrate 160 surface, and are subsequently displaced by new pollutant molecules, thereby replenishing the catalytically active catalyst substrate 160 surface. The carbon monoxide, formaldehyde, and reactive VOCs can be oxidized completely to CO₂ and water.

In one embodiment, the catalytic substrate 160 is a catalyst coated ceramic brick 190, shown in FIG. 3. A plurality of such bricks 190 can be disposed serially within the catalyst holding arms 130, and can be aligned by matching prefabricated notches in the bricks 190. The ceramic bricks 190 can have a thin-wall honeycomb geometry with a nominal density of 600 cells/in². In one embodiment, a metal oxide coating consisting of about 1-50% by mass of tin oxide with about 0-40% by mass other oxide materials that include, but are not limited to, cerium oxide, zirconium oxide, and lanthanum oxide, is applied to the brick from a solution phase of ethylhexanoate solutions, deaerated, and heated to evaporate the residual solvent and thermally decompose the absorbed ethylhexanoate solution to the corresponding metal oxide. Additional transition metals, which include, but are not limited to, iron, cobalt, and nickel, are then applied from metallic salt solutions (about 0-15% relative to final oxide mass) to the oxide coating to improve the surface conductivity and facilitate the oxidation of formaldehyde and other VOCs. Finally, noble or precious metal species, which include, but are not limited to, platinum, palladium, and rhodium are applied from metal salt solutions, deaerated, and thermally reduced to oxide species as described above. In at least one embodiment, the noble metal loadings can range from sub-1% relative to the total metal oxide mass, to 20% or higher. The platinized and promoted tin oxide catalyst formulations represent an embodiment that incorporates iron, nickel, and cobalt as promoter species. Prior to use, the catalyst-coated substrates are subjected to a flowing reducing gas such as 10% CO or hydrogen (H₂) at elevated temperature (e.g., 125° C.) for a period of 6 hours to enhance catalytic efficiency. Once completed, the bricks 190 can be stored for extended periods (e.g., typically months to years) prior to use.

In addition to catalyst coated bricks 190, the catalyst substrate 160 can comprise a variety of materials, for example, the substrate can also be catalyst coated particles (e.g., silica, alumina) or beads, fabrics, or filter materials, not shown. As such, the present invention exhibits tremendous packaging flexibility that can contribute favorably to its successful integration into new and existing facilities.

Longevity and durability of the catalyst substrates 160 will be highly application dependent and driven by the concentration of catalytic poisons, such as sulfur, and particulate matter, such as oil and grease, in the exhaust gas stream. Many industrial facilities incorporate particulate filters prior to exhausting the emission into the environment, thereby mitigating the risk of catalytic poisoning. Additional filtering within the present invention would further reduce the potential for catalytic poisoning and extend the longevity of the replaceable catalyst substrates 160. FIG. 1 shows an optional passive filter 200, located upstream from the catalyst holding arms 130 and downstream from the oxygen enrichment system 120. Upstream of the filter 200, there can be an upstream filter cut-off valve 210. Similarly, there can be a downstream filter cut-off valve 220 downstream of the filter 200.

For some applications, existing techniques that are currently commercially available can be applied to refresh degraded catalyst substrates 160, further reducing the maintenance cost of the present invention.

After passing through the plurality of catalyst holding arms 130, the plurality of exhaust gas streams are recombined in the exhaust gas exit section 140. As was the case with the exhaust gas inlet section 110, the exhaust gas exit section 140 can be designed to mate to existing exhaust gas plumbing systems for industrial facilities, thereby allowing the present invention to be installed in a new facility or as an upgrade to an existing facility. Alternately, each of the plurality of catalyst holding arms can be plumbed directly to the smoke stack of the facility.

Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention as defined in the following claims. In the claims, means-plus-function and step-plus-function clauses are intended to cover the structures or acts described herein as performing the recited function and not only structural equivalents, but also equivalent structures.

What is claimed as new and desired to be secured by Letters Patent of the United States is:

1. An exhaust gas treatment apparatus comprising:
an exhaust gas inlet section,
a plurality of catalyst holding arms, located downstream from said oxygen enrichment system and arranged in a flow configuration, wherein a single exhaust stream flowing through said exhaust gas inlet section is separated into a plurality of exhaust gas streams, and
at least one catalyst coated substrate disposed within each of said catalyst holding arms.

2. The exhaust gas treatment apparatus according to claim 1, further comprising an oxygen enrichment system, located downstream from said exhaust gas inlet section.

3. The exhaust gas treatment apparatus according to claim 1, further comprising an exhaust gas outlet section, wherein said plurality of exhaust gas streams from each of said catalyst holding arms is recombined into said single exhaust gas stream.

4. The exhaust gas treatment apparatus according to claim 2, wherein said oxygen enrichment system comprises an active oxygen enrichment system.

5. The exhaust gas treatment apparatus according to claim 2, wherein said oxygen enrichment system comprises a passive oxygen enrichment system.

6. The exhaust gas treatment apparatus according to claim 5, wherein said passive oxygen enrichment system comprises a plurality of oxygen enrichment ports.

7. The exhaust gas treatment apparatus according to claim 5, wherein said passive oxygen enrichment system comprises at least one oxygen enrichment port.

8. The exhaust gas treatment apparatus according to claim 5, wherein said passive oxygen enrichment system comprises four oxygen enrichment ports.

9. The exhaust gas treatment apparatus according to claim 1, further comprising a filter located between said exhaust gas inlet section and said catalyst holding arms.

10. The exhaust gas treatment apparatus according to claim 9, wherein said filter comprises a passive air filter.

11. The exhaust gas treatment apparatus according to claim 9, further comprising an upstream filter cut-off valve, located upstream of said filter.

12. The exhaust gas treatment apparatus according to claim 9, further comprising a downstream filter cut-off valve, located downstream of said air filter and upstream of said catalyst holding arms.

13. The exhaust gas treatment apparatus according to claim 11, further comprising a downstream filter cut-off valve, located downstream of said air filter.

14. The exhaust gas treatment apparatus according to claim 1, wherein each of said plurality of catalyst holding arms further comprises:
an upstream holding arm isolation valve, located upstream of said at least one catalyst coated substrate, and
a downstream holding arm isolation valve, located downstream of said at least one catalyst coated substrate.

15. The exhaust gas treatment apparatus according to claim 1, wherein each of said plurality of catalyst holding arms further comprises a thermal control means.

16. The exhaust gas treatment apparatus according to claim 15, wherein said thermal control means comprises heat tape.

17. The exhaust gas treatment apparatus according to claim 1, wherein said plurality of catalyst holding arms comprises at least six catalyst holding arms.

18. The exhaust gas treatment apparatus according to claim 1, wherein said at least one catalyst coated substrate comprises at least one of:
bricks,
particles,
beads,
mesh,
screen,
fabrics, and
filter materials.

19. The exhaust gas treatment apparatus according to claim 18, wherein said at least one catalyst coated substrate comprises at least one catalyst coated brick, and each of said at least one catalyst coated brick comprises a thin wall honeycomb geometry structure.

20. The exhaust gas treatment apparatus according to claim 18, wherein said at least one catalyst coated substrate comprises a catalyst coating comprising at least one of:
tin oxide,
oxide material,
transition metal, and
noble metal.

21. The exhaust gas treatment apparatus according to claim 20, wherein said catalyst coating comprises about 1 to 50 percent by mass tin oxide, about 0 to 40 percent by mass oxide material, about 1 to 15 percent by mass transition metal, and about 0 to 50 percent by mass noble metal.

22. The exhaust gas treatment apparatus according to claim 21, wherein said oxide material comprise at least one of:
cerium oxide;
zirconium oxide; and
lanthanum oxide

23. The exhaust gas treatment apparatus according to claim 1, wherein said oxide material comprise at least one of:
zirconium oxide; and
lanthanum oxide.

24. The exhaust gas treatment apparatus according to claim 20, wherein said transition metal comprises at least one of:
nickel,
iron, and
cobalt.

25. The exhaust gas treatment apparatus according to claim 20, wherein said noble metal comprises at least one of:
platinum,
ruthenium
palladium, and
rhodium.

26. The exhaust gas treatment apparatus according to claim 1, wherein said plurality of catalyst holding arms are arranged in a substantially parallel flow configuration.

27. An exhaust gas treatment apparatus comprising:
an exhaust gas inlet section,
at least one oxygen enrichment port, located downstream from said exhaust gas inlet section,
an air filter located downstream of said at least one oxygen enrichment inlet port, an upstream air filter cut-off valve, located upstream of said air filter, and a downstream air filter cut-off valve, located downstream of said air filter,
a plurality of catalyst holding arms, located downstream from said at least one oxygen enrichment port and arranged in a parallel flow configuration, wherein a single exhaust stream flowing through said exhaust gas inlet section is separated into a plurality of exhaust gas streams, and wherein each catalyst holding arm comprises at least one catalyst coated substrate disposed within each of said catalyst holding arms, an upstream holding arm isolation valve, located upstream of said at least one catalyst coated substrate, and a downstream holding arm isolation valve, located downstream of said at least one catalyst coated substrate, and
an exhaust gas outlet section, wherein said plurality of exhaust gas streams from each of said catalyst holding arms is recombined into said single exhaust gas stream.

28. The exhaust gas treatment system according to claim 27, wherein said plurality of catalyst holding arms comprises at least six catalyst holding arms.

29. The exhaust gas treatment system according to claim 27, wherein said air filter comprises a passive air filter.

30. The exhaust gas treatment apparatus according to claim 27, wherein each of said plurality of catalyst holding arms further comprises a thermal control means.

31. The exhaust gas treatment apparatus according to claim 30, wherein said thermal control means comprises heat tape.

32. A method of treating an exhaust gas, comprising the steps of:
splitting an exhaust gas stream into a plurality of parallel exhaust gas streams,
passing each of said plurality of parallel exhaust gas streams through a catalyst coated substrate, and
recombining said plurality of parallel exhaust gas streams into a single exhaust stream.

33. The method of treating an exhaust gas according to claim 32, further comprising the step of filtering said exhaust gas stream prior to said splitting step.

34. The method of treating an exhaust gas according to claim 33, wherein said filtering step comprises passing said exhaust gas stream through an air filter.

35. The method of treating an exhaust gas according to claim 34, wherein said air filter is a passive air filter.

36. The method of treating an exhaust gas according to claim 32, further comprising the step of enabling one or more of said plurality of parallel exhaust gas streams to be selectively closed off using an upstream isolation valve and a downstream isolation valve.

37. The method of treating an exhaust gas according to claim 32, further comprising the step of enriching said exhaust gas stream with oxygen,

38. The method of treating an exhaust gas according to claim 32, wherein said catalyst coated substrate comprises a catalyst coating comprising at least one of:
tin oxide,
oxide material,
transition metal, and
noble metal.

39. An exhaust gas treatment apparatus comprising:
an exhaust gas inlet section,
an air filter located downstream of said exhaust gas inlet section, an upstream air filter cut-off valve, located upstream of said air filter, and a downstream air filter cut-off valve, located downstream of said air filter,
a plurality of catalyst holding arns, located downstream from said exhaust gas inlet section and arranged in a flow configuration, wherein a single exhaust stream flowing through said exhaust gas inlet section is separated into a plurality of exhaust gas streams, and wherein each catalyst holding arm comprises at least one catalyst coated substrate disposed within each of said catalyst holding arms, an upstream holding arm isolation valve, located upstream of said at least one catalyst coated substrate, and a downstream holding arm isolation valve, located downstream of said at least one catalyst coated substrate, and
an exhaust gas outlet section, wherein said plurality of exhaust gas streams from each of said catalyst holding arms is recombined into said single exhaust gas stream.

40. The exhaust gas treatment system according to claim 39, further comprising at least one oxygen enrichment port, located downstream from said exhaust gas inlet section.
